(19) United States
(12) Patent Application Publication
(10) Pub. No.: US 2002/0025827 A1
(43) Pub. Date: Feb. 28, 2002

(54) Extendable antenna for wireless telephones

(76) Inventor: Chang June Song, Richmond (CA)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/905,487

(22) Filed: Jul. 13, 2001

Related U.S. Application Data
(63) Continuation-in-part of application No. 09/643,006, filed on Aug. 21, 2000.

(51) Int. Cl. H04M 1/00

(52) U.S. Cl. 455/550; 455/575

(57) ABSTRACT

A wireless telephone includes an antenna that is releasably housed by the enclosure of the telephone to extend to an extendable, operating position for use.

### CROSS-REFERENCES TO RELATED APPLICATIONS

This is a continuation-in-part application of U.S. application Ser. No. 09/643,006, filed Aug. 21, 2000, (hereinafter, “Referenced Application”), the disclosure of which is hereby incorporated by reference as if fully set forth herein.

### BACKGROUND OF THE INVENTION

Wireless phone technologies and the art of microelectronics and microelectronic packaging have been combined to produce wireless or cell telephones that are very small in size, so small in fact that a person can carry one in a shirt pocket. However, a wireless telephone must have an antenna in order to operate properly, a feature that can limit how and by what a wireless telephone may be carried. Torn pockets and broken antennas are just some of the possible results of this limitation.

One solution typically employed by cell phone manufacturers is to use a small, thin whip-like antenna that may or may not telescopically be pulled from the body of the phone for use. Later the antenna may be pushed back into the phone when not in use. But, the extension of the antenna is not always remembered, causing the user to believe the phone is inoperative if not connection is made. Also, repeated manipulation of some antenna constructions of this type can result in breakage, bending, or other damage.

Accordingly, there is a need for an antenna that can be easily and/or automatically extended from and retracted into a wireless telephone.

### BRIEF SUMMARY OF THE INVENTION

The present invention provides various methods and apparatus for extending and retracting an antenna of a wireless telephone that are easy to implement and use.

Broadly, the present invention is directed to providing a wireless telephone with an antenna system that releases easily antenna from a retracted position to an extended position for use. Retracting the antenna into a housed location protects it from harm.

One embodiment of the invention has the antenna locates the antenna in an antenna housing that is pivotally connected to the body of the wireless telephone for movement between a closed position with the housing in a recess of the body to an extended position. An aspect of this embodiment of the phone is incorporated a flip-top design so that, when the phone is opened for use, the antenna housing is released to pivot to the extended position. Another aspect of this embodiment uses a flip-bottom design to the same effect.

A further embodiment of the invention employs a detent to provide a positive hold on the antenna housing when its closed or extended position.

Still another embodiment of the invention uses a telescoping antenna with a bias element to expel the antenna from the phone body.

An advantage of the invention is that by retracting the antenna into the body of the phone when not in use operates to protect the antenna from damage. Also, by containing the antenna in a housing, smaller, lighter, more fragile antenna may be used.

These and other aspects and advantages of the invention will become apparent to those of ordinary skill in this art upon a reading of the following detailed description of the invention, which should be taken in conjunction with the accompanying drawings.

### BRIEF DESCRIPTION OF THE DRAWINGS

FIG. 1 illustrates a wireless telephone with a foldable earpiece and an extendable antenna according to one embodiment of the invention;

FIG. 2 illustrates the wireless telephone of FIG. 1 in folded position;

FIG. 3 illustrates a wireless telephone with a foldable speaker piece and an extendable antenna according to another embodiment of the invention;

FIG. 4 illustrates the wireless telephone of FIG. 3 in a folded position;

FIG. 5 is a perspective view of a one-piece wireless telephone with an extendable antenna pivotally attached;

FIGS. 6 and 7 illustrate the detent used to hold the extendable antenna in the retracted or extended positions;

FIG. 8 is another embodiment of a pivotally mounted antenna construction for the wireless telephone of FIGS. 1 or 3;

FIG. 9 is a sectional view of the antenna of FIG. 8 taken along the lines 9-9;

FIG. 10 is a sectional view of the antenna of FIG. 9 taken along the lines 10-10 of FIG. 12; and

FIGS. 11-13 are further embodiments of the invention, illustrating antenna housing release mechanisms that employ a solenoid (FIG. 12) or an electromagnetic element (FIG. 13).

### DETAILED DESCRIPTION OF THE INVENTION

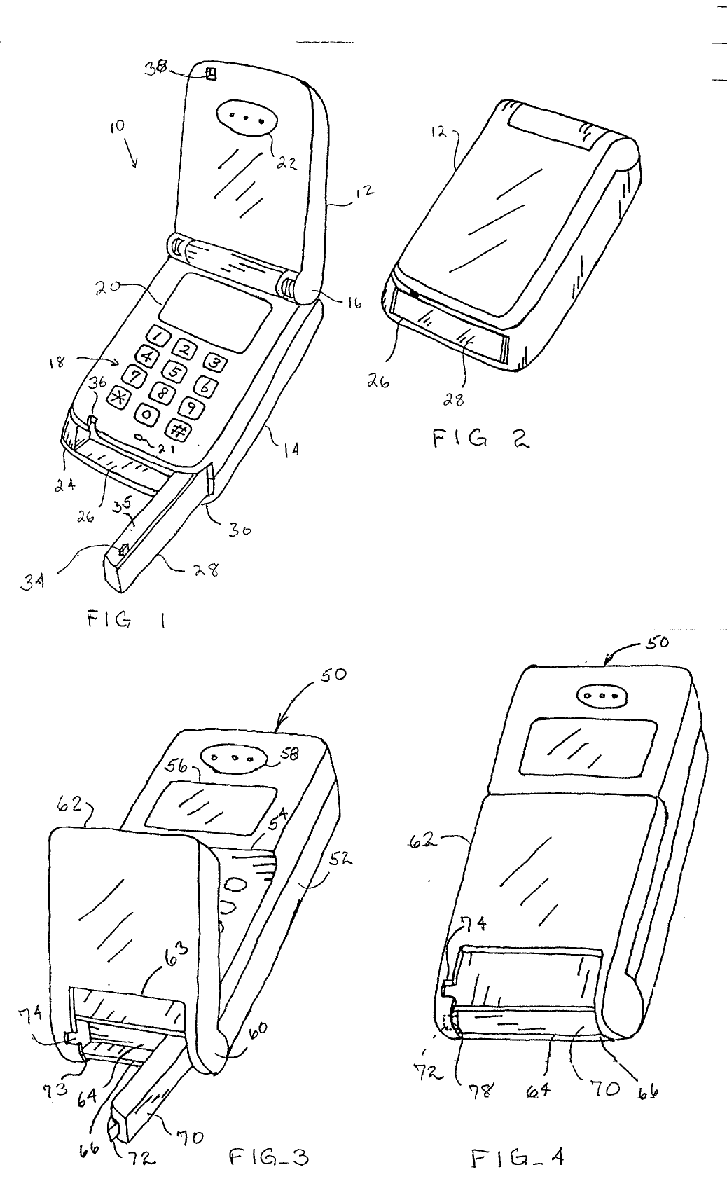

Turning now to the Figures, FIGS. 1 and 2 show an embodiment of the invention for a wireless phone with a foldable earpiece. A phone 10 of generally conventional design, except for the present invention to be described, is shown constructed with from a foldable earpiece 12 that is pivotally joined to the phone body 14 at 16. The body 14, will contain the usual working/operating electronics (not shown) and carries a keypad 18, a display 20, and a microphone aperture 21 to provide access to the microphone (not shown) contained in the body 14. Speaker apertures 22 are formed in the foldable earpiece 12 to allow sound produced by a speaker (not shown) or other transducer to be emitted from the phone.

Formed at a bottom 24 of the body 14 is a recess 26 that is configured to receive and removably hold an antenna housing 28 containing the antenna (not shown) of the phone 10. The antenna housing 28 is mounted at 30 for rotation into and out of the recess 26, between a retracted (FIG. 2 and an extended position FIG. 1) position.

A tab 34 formed on a sidewall 35 of the antenna housing 28. The tab 34 is sized and placed to extend through a notch 36 formed in the end 24 of the body 14 so that it can be captured and held by an indentation 38 formed in the earpiece 12. Preferably, the tab 34 is biased outward, away from the antenna housing 28, such as by a spring (not shown) or other mechanism, so that it can be depressed into the antenna housing 28. This allows the earpiece 12 to first be closed to cover the keyboard 18. Then, the antenna housing 28 can be moved into the recess 26, depressing the tab 34 until it can pop into the indentation 38, which will be registered with the notch 36.

When the antenna housing 28 is rotated into the recess 26, the tab 36 will extend through the notch 36 so that when the earpiece 12 is closed, (i.e., rotated to a position proximate and covering the keypad 18 and display 20) the indentation 38 captures the tab to hold the antenna housing 28 in place in the recess 26. When the earpiece 12 is moved to its open position, shown in FIG. 1, the tab is released, allowing the antenna housing to rotate to its extended position. Preferably, the connection of the antenna housing 28 to the body 14 will include some form of bias element (not shown), such as a spring, that provides the motive force for moving the antenna housing to its extended position when released.

Not specifically shown is the operating antenna for the wireless telephone 10, although as indicated above, it is contained in the antenna housing 28, which provides protection for the antenna. Such protection allows the antenna construction to be much more fragile, in turn permitting a wider variety of antenna designs.

FIGS. 3 and 4 illustrate the present invention incorporated in a flip-bottom phone construction. FIG. 3 shows a wireless phone 50 with a body 52 with the usual keypad 54, display 56, earpiece 58, and of course the operating electronics (not shown) housed within the body 52. Rotatably or pivotally attached to the body 52 at 60 is a flip-bottom 62. A recess 64 is formed at the end 66 of the body 52 for receiving the antenna housing 70. Antenna housing 70, like the antenna housing 28 of FIGS. 1 and 2 (see also FIG. 6, described below), will contain the antenna (not shown) for the phone 50. Preferably, the antenna housing 70 is biased, as by a spring (not shown) or other mechanism, to cause it to be rotated to the extended position shown in FIG. 3.

The pivot end of the flip-bottom 62 is cut out at 63 and is formed to have a short, annular wall-like cutout construction 73 with a notch 74 cut therein. The end of the antenna housing 70 has a tab 72 extending therefrom. The notch 74 formed in the cutout 73 provides release egress from the annular interior of the cutout 73, which operates to hold the antenna housing in the recess 64. Rotating the flip-bottom 62 to its closed position (FIG. 4), covering the keypad, and then rotating the antenna housing 70 into the recess 64 will capture the tab 72, and with it the antenna housing 70, to hold the antenna housing 70 in the recess 64. When the flip-bottom 62 is rotated to its open position, as partially shown in FIG. 3, the notch 74 will rotate to a position that will release the tab 72 from the cutout 74, and allow the (spring-biased) antenna housing 70 to move from its retracted position in the recess 64 (FIG. 4) to the extended position shown in FIG. 3.

As with the tab 34 of the embodiment of FIG. 1, discussed above, the tab 72 may be biased outward away from the antenna housing 70, such as by a spring (not shown), so that it can be depressed into the housing. This allows the tab 72 to depress into the antenna housing 70 so that the tab can be placed within the cutout 73 to hold the antenna housing 70 in its retracted position.

FIGS. 5-7 show a further embodiment of the present invention. Here, a wireless phone 90 is of one-piece construction in the sense that there is no flip-top or bottom elements as was shown in FIGS. 1-4. The wireless phone 90 has a body 92 formed from top and bottom plates 94 and 96, respectively, to contain the operating components of the phone. Again, a recess 100 is formed in the bottom 102 of the body 92 to receive and embrace an antenna housing 104. The antenna housing 104 is pivotally mounted to the body 92 by a bolt 106 (see FIGS. 6 and 7) for rotational movement from the recess 100 to the extended position illustrated in FIG. 7 for phone operation. The terminus 105 of the antenna housing 104 is knurled for reasons that will be made clear below.

FIGS. 6 and 7 illustrate the antenna housing in its closed or retracted and extended positions, respectively. A detent, comprising a pivot member 110 with notches 112 and 114 for cooperative engagement with a spring 118, operates to hold the antenna housing 104 in one of its two stable positions: in the recess and extended. A stop 120 is mounted to the enclosure to cushion the return of the antenna housing 104 to the recess 100 from its extended position. The stop 120 is preferably fabricated from a malleable material, such as rubber, to provide the desired cushioning.

When in the recess, the antenna housing may be extended by finger pressure on the knurled terminus 105 with sufficient force to overcome the bias of the engagement of the detent formed by the spring 118 and the notch 112 (FIG. 6). When the holding power of the detent is overcome, the antenna housing may then be moved to the extended position (FIG. 7) where the detent formed by spring 118 and notch 114 releasably lock the antenna housing 104 in place as illustrated in FIG. 7.

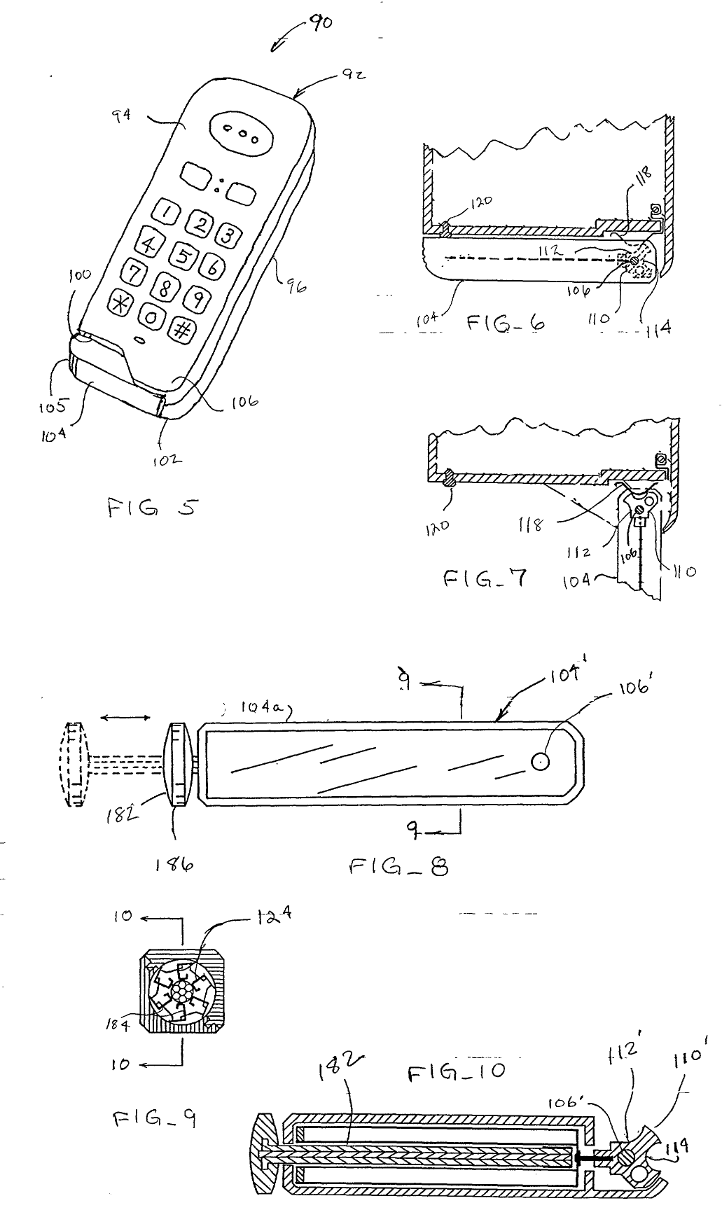

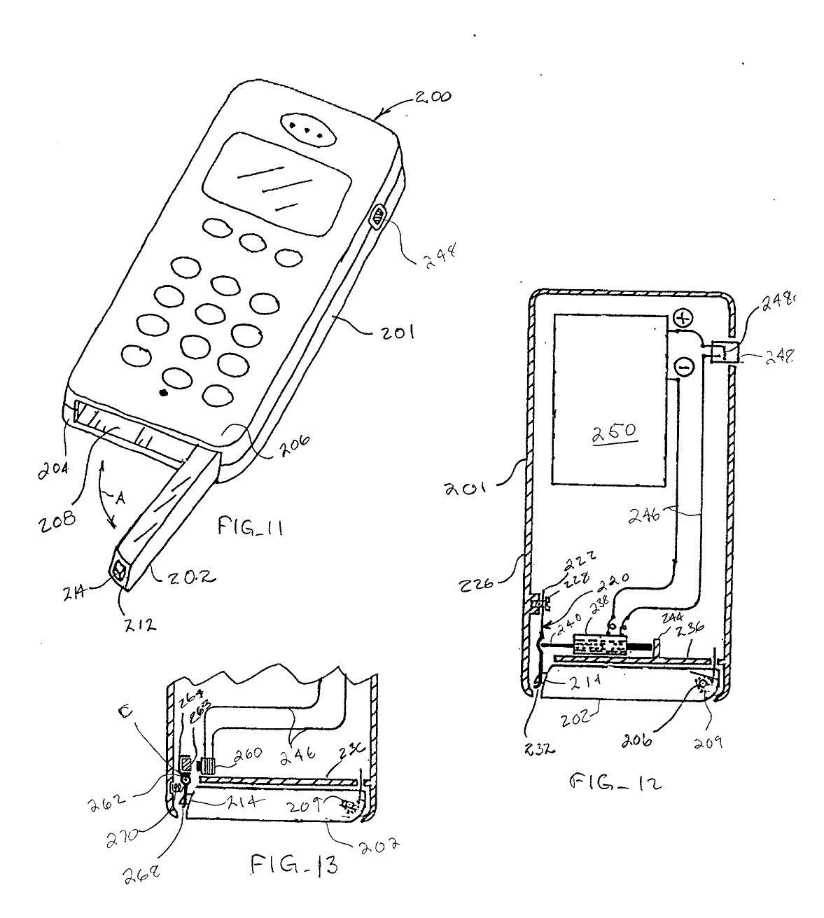

Turning now to FIGS. 8-10, an alternative to the pivotally-attached antenna show in FIGS. 1-5. As seen in FIG. 8, the antenna housing 104 shown in FIGS. 5-7 is replaced with an antenna assembly 104′ that is configured to mount to the wireless telephone 90 for pivotal movement about the journal 106′ formed in the antenna housing 104a. The antenna assembly includes an elongate antenna element 182 that is frictionally held in place by spring pieces 184 (FIG. 9). A button 186 is formed at a terminus of the antenna element 106′ for grasping and pulling the antenna from the antenna housing 104a. The antenna assembly 104′ is mounted using a detent much like the embodiment shown in FIGS. 6 and 7, comprising pivot member 110′ that is notched at 114′ and 116′ for engagement with the spring 118 (FIGS. 6 and 7) to hole the antenna assembly in a retracted position or an extended position, respectively.

In use, when used with the wireless telephone 90 (FIG. 5), replacing the antenna housing 104 (and enclosed antenna), the antenna assembly 104′ would mount the same way: for pivotal movement from the retracted position shown in FIG. 5, to the extended position illustrated in FIG. 7. The antenna assembly 104′ is locked in place by the detent, i.e., the interaction between the notches 112′ and 114′ formed in the pivot member 110′ and the spring 118 (FIGS. 6 and 7). When the antenna assembly is in its extended position, the antenna element 182 can be pulled from the antenna housing 104a to extend therefrom.

After use of the wireless telephone 90, as modified by using the antenna assembly 104′, the antenna element may be pushed back into the housing 104a, where it will be held in place by the frictional engagement between the antenna element and the spring pieces 184. The antenna housing may then be urged with sufficient force to overcome the holding power of the spring 118 and the notched pivot member 110′ to rotate the assembly into the recess 100 of the wireless telephone 90.

FIGS. 11-13 illustrate further embodiments of the invention. Turning first to FIGS. 11-12, a wireless telephone 200 is structured to have a housing 201 that includes an antenna 202 pivotally attached to the end 204 of the telephone 200 at 206 (FIG. 12) so that it can swing in the direction of the arc A (FIG. 11) into and out of a recess 208 formed in the housing 201. The antenna housing 202, like those discussed above, will include, enclose, and protect the operating antenna structure (not shown) used for transmission and reception. Also, although not shown in order not to unduly complicate the drawings and detract from the understanding of the invention, it will be evident that the operating electronics of the wireless telephone 200 will be included in the housing 201.

Formed at the end 212 of the antenna housing 202 is a tab 214 that, as will be seen, forms a part of a release mechanism to release the antenna housing from a position held within the recess 208 to the extended position illustrated in FIG. 11. FIG. 12 shows one embodiment of the release mechanism, the major components of what are a spring element 220 and a solenoid 238. The spring element 220 has one end 222 affixed to the sidewall 226 in conventional fashion such as, for example, by a fastening member 230. The other end 232 of the spring is shaped to bend away from the recess 208 apertured to receive and hold the tab 214 when the antenna housing 202 is retracted into the recess 208. A spring 209 encircles the pivot 206 to bias the antenna housing 202 toward the extended position.

Mounted on a bottom wall 236 of the wireless phone 200 is the solenoid mechanism 238, which includes a projecting arm 240. The solenoid mechanism 238 is oriented to aim the arm 240 toward the spring element 220 to push it away from the recess 208 when activated. A stop 244 operates to limit the return travel of the arm 240 when the solenoid mechanism is deactivated to move the arm away from the spring.

An electrical circuit, including electrical wires 246 and push-button switch 248, connect a battery 250 to the solenoid mechanism 238. Depressing the push-button switch 248 will effect closure of a switch 248a to electrically connect the battery to the solenoid mechanism 238 for activation. When so activated, the arm 240 will be expelled outward from the solenoid mechanism 238 in conventional fashion toward the spring 220 The travel of the arm 240 will, in turn, cause is to engage and move the spring end 232 back toward the sidewall 226 of the housing 201 and release the antenna housing 232. The bias applied by the spring 209 swings the antenna housing 202 from its retracted position (illustrated in FIG. 12) with the recess 208 to the extended position shown in FIG. 11.

An alternate release mechanism is shown in FIG. 13. This alternative replaces the solenoid mechanism 238 in favor of an electromagnet 260, the winding of which is connected to the electrical wiring 246 and to the battery 250 through the push-button switch 248 (FIG. 12). Although not specifically shown, it will be appreciated that the electromagnet mounts to the bottom wall 236 by any conventional means. The release mechanism of this embodiment uses a pivot arm 262 that carries a magnetic element 263 at the end 264 of the pivot arm. The other end 268 of the pivot arm 262 is apertured to capture and hold the tab 214 of the antenna housing when the antenna housing is placed in its retracted position in the recess 208 as illustrated in FIG. 13

The pivot arm 262 is mounted to pivot about a point C. When the push-button 248 is depressed to close the switch contacts 248a, electrical current will be applied through the electrical wiring 246 to the electromagnet 260. In turn, the electromagnet 260 will generate a magnetic field that will exert a pull on the magnetic material 263 to pull the end 264 toward the electromagnet, and at the same time push the apertured end 268 away from the antenna housing. This pivoting action releases the antenna housing 202, and when so released, the antenna housing will be biased from the recess to the extended position of FIG. 11 by the spring 209.

Although not specifically discussed or shown, it will be evident to those skilled in this art that the various antenna constructions of the embodiments of the invention are electrically coupled to the necessary phone electronics by a number of known techniques. Additionally, it will be appreciated by those skilled in this art that although the antenna construction of the present invention has been illustrated as being located at the remote end of the wireless telephone (i.e., the end further from the speaker end), it could be located at either end. The reason for the location of the antenna structure as illustrated is that it removes the antenna structure from close proximity to the ear and head (and therefore brain) of the user, lessening any harmful effects that may result from the RF energy emitted by the antenna.

What is claimed is:

1. A wireless telephone, including:
an enclosure;
an antenna; and
an antenna system, including,
a housing containing the antenna, the antenna housing being mounted to the enclosure for movement between a first position to hold the antenna in a retracted position and a second position for extending the antenna, and
a bias member coupled to the antenna housing to bias the antenna housing toward the second position.

2. A wireless telephone of a type formed from first and second phone parts pivotally joined together to allow the first phone part to open from a folded position with the second phone part for use, the first and second phone parts forming an enclosure, and including:
an antenna housing mounted to the second phone part for movement from a first position within the second part to an extended position;
an antenna mounted in the housing;
a release element mounted to hold the antenna housing in the first position; and
a bias member to bias the antenna housing to the extended position when the release member is disposed to release the antenna housing.

3. The wireless telephone of claim 2, wherein the bias member is a spring.

4. The wireless telephone of claim 3, wherein the bias member is a helical spring.

5. The wireless telephone of claim 2, wherein the antenna housing is pivotally mounted to the second phone part to pivot to the second position when released by the release member.

6. The wireless telephone of claim 5, wherein the antenna is telescopically mounted in the antenna housing to be extracted from the antenna housing when in the second position.

7. The wireless telephone of claim 2, the release member including tab formed on the antenna housing, the first phone part having a recess formed and configured to receive and hold the tab when the first phone part is in the folded position, holding the antenna housing in the first position.

8. A wireless telephone, including;
an outer shell forming an enclosure having an opening;
an antenna holder mounted in the enclosure and having an end located proximate the opening;
an antenna releasably held in the antenna holder for movement between a retracted position within the antenna holder and a second position extending from the antenna holder and through the opening;
a movable latch member mounted to releasably hold the antenna in the antenna holder; and
a bias coupled to the antenna to move the antenna from the first position to the second position when the moveable latch member is moved to release the antenna.

9. A wireless telephone, including:
an enclosure for housing working elements of the wireless telephone, the enclosure having at least a partial recess;
an antenna system, including,
an antenna,
a housing, containing the antenna, pivotally mounted to the enclosure for movement between a retracted position and an extended position; the recess being formed and configured to hold the housing when in the retracted position, and
a bias member coupled to the antenna housing to bias the antenna housing toward the second position.

10. The wireless telephone of claim 9, wherein the enclosure includes a first phone part and a second phone part pivotally joined for the first phone part to move from a folded position juxtaposed with the second phone part to an open position, there being formed in the first part a barrel having a notch, the housing having a terminal end with a tab formed to extend therefrom captured by the barrel, whereby the housing is released to move toward the second position when the first phone part rotates from the folded position to the second position to let the tab pass through the notch.

11. A wireless telephone of a type having an enclosure for housing working and electronic elements of the wireless telephone, the enclosure having at least a partial recess, and including
an antenna system, including,
an antenna,
a housing, containing the antenna, pivotally mounted to the enclosure for movement between a retracted position and an extended position; the recess being formed and configured to hold the housing when in the retracted position, and
a captivation system, including a detent, to releaseably hold the housing in the retracted and extended positions.

12. The wireless telephone of claim 11, wherein the detent includes a spring mounted to the enclosure and a detent member mounted to the housing.

13. The wireless telephone of claim 12, including a bend in the spring, and wherein the detent member has formed therein first and second notches, spring and detent member being positioned so that the first notch matingly engages the bend to hold the housing in the retracted position and the second notch matingly engages the bend to hold the housing in the extended position.

14. The wireless telephone of claim 11, the wherein the antenna is movably mounted to telescopically extend from and retract into the housing.
